(19) United States
(12) Patent Application Publication
(10) Pub. No.: US 2007/0277604 A1
(43) Pub. Date: Dec. 6, 2007

(54) Modular Measuring Device

(75) Inventors: Robert Cudini, Reinach (CH); Bruno Worreth, Kiffis (FR); Ivo Braegger, Reinach (CH); Cedric Jeanneret, Reinach (CH); Kilian Stern, Buhlertal (DE)

Correspondence Address: BACON & THOMAS, PLLC, 625 SLATERS LANE, FOURTH FLOOR, ALEXANDRIA, VA, 22314, US

(73) Assignee: Endress + Hauser Flowtec AG, Reinach (CH)

(21) Appl. No.: 10/584,276

(22) PCT Filed: Dec. 15, 2004
(86) PCT No.: PCT/EP04/53517

§ 371 Date: May 21, 2007

(30) Foreign Application Priority Data
Dec. 23, 2003 (DE) 103 61 461.3

(51) Int. Cl. G01D 11/24

(52) U.S. Cl. 73/431

(57) ABSTRACT

A measuring device, includes: a sensor module having a sensor compartment in which a physical-to-electrical sensor is arranged; and an electronics module, having an electronics compartment, in which a measuring device electronics is arranged. Additionally, the measuring device includes a first connecting element mounted on the electronics module and electrically connected with the measuring device electronics, and a second connecting element mounted on the sensor module and electrically connected with the sensor. Sensor module and electronics module are releasably, mechanically connected together, accompanied by formation of a connecting compartment lying between the sensor compartment and the electronics compartment, and, preferably, sealed fluid-tightly, and/or pressure-tightly, relative to a surrounding atmosphere. The two connecting elements are connected together electrically, especially galvanically, so that measuring device electronics and sensor are electrically coupled together, and the two connecting elements, connected with one another, are accommodated in the connecting compartment formed between sensor compartment and electronics compartment.

The invention relates to a modular measuring device, including a sensor module, in which a sensor is arranged, and an electronics module, in which a measuring device electronics is arranged.

Measuring devices, especially field measuring devices installed on-site, form the basis of industrial measuring and control technology. Thus, measuring devices are used e.g. in almost all industrial plants, e.g. in plants of the chemicals and foods industries or in water treatment plants, in order to measure or monitor, on-site, process variables, such as e.g. pressure, temperature, fill level, flow, or other measured variables. The measuring devices are situated in a measuring location and contain a physical-to-electrical sensor, which registers the desired process variable and converts it into an electrical signal. The electrical signal is fed to an electronics, which further processes the signal and converts it into an electrical output signal, which enables display and/or forwarding of the measurement results.

Thus, for example, in EP-A 984 248, a modular measuring device is described, which includes:
a sensor module
having a sensor compartment, in which a physical-to-electrical sensor is arranged; and
an electronics module
having an electronics compartment, in which a measuring device electronics is arranged; as well as
a first connecting element mounted on the electronics module and electrically connected with the measuring device electronics, and a second connecting element mounted only on the first connecting element and electrically connected with the sensor;
wherein sensor module and electronics module are releasably, mechanically connected together, accompanied by the formation of a connecting compartment lying between sensor compartment and electronics compartment, especially a connecting compartment sealed fluid-tightly, and/or pressure-tightly, against the surrounding atmosphere;
wherein, for connecting the measuring device electronics to the sensor, the two connecting elements are electrically, especially galvanically, connected together, so that the measuring device electronics and sensor are electrically coupled together; and
wherein the two connecting elements, connected together, are accommodated in the connecting compartment formed between sensor compartment and electronics compartment.

The disclosed electronics module has, additionally, an opening, which can be closed by means of a housing lid. Through such opening, the measuring device electronics can be inserted into the electronics module. In the case of possibly required repairs of the measuring device electronics, the housing lid then has to be opened again. The electrical connections have to be manually separated, and the circuit boards removed and replaced by new ones.

The removing and applying of the housing lid, and a circuit board, requires working space, since either the circuit board must be extracted from the electronics module or the housing lid must be guided over the circuit board. Moreover, for later again effecting secure electrical connections, it is usually necessary to assure that the plugs and sockets can be viewed. In bottling plants for liquids wherein, in very tight spaces, numerous field measuring devices, as well as various kinds of other equipment, are accommodated, there is usually not sufficient space to enable exchange of the measuring device electronics. Additionally, it is often not possible to view the connection between the electronics module, which is usually left installed, and the measuring device electronics, so that the effecting of the electrical connections is most often subject to considerable difficulties.

It is, therefore, an object of the invention to provide a measuring device, in which possible repair or exchange of the measuring device electronics can be performed simply and rapidly, especially under the usually tight space conditions in bottling plants.

For achieving such object, the invention resides in a modular measuring device including:
a sensor module
having a sensor compartment, in which a physical-to-electrical sensor is arranged; and
an electronics module
having an electronics compartment, in which a measuring device electronics is arranged; as well as
a first connecting element mounted on the electronics module and electrically connected with the measuring device electronics, and a second connecting element mounted on the sensor module and electrically connected with the sensor;
wherein sensor module and electronics module are releasably, mechanically connected together, accompanied by the formation of a connecting compartment lying between sensor compartment and electronics compartment, especially a connecting compartment sealed fluid-tightly, and/or pressure-tightly, against the surrounding atmosphere;
wherein the two connecting elements are electrically, especially galvanically, connected together, so that the measuring device electronics and sensor are electrically coupled together; and
wherein the two connecting elements, connected together, are accommodated in the connecting compartment formed between sensor compartment and electronics compartment.

In a first embodiment of the measuring device of the invention, at least one of the two connecting elements is movably mounted.

In a second embodiment of the measuring device of the invention, at least one side wall of at least one of the two connecting elements has at least one essentially straight projection and at least one side wall of the connecting compartment has at least one, essentially straight groove corresponding with the projection of the connecting element, with the projection of the connecting element being received by the groove of the connecting compartment.

In a third embodiment of the measuring device of the invention, at least one side wall of at least one of the two connecting elements has at least one essentially straight groove and at least one side wall of the connecting compartment has an essentially straight projection corresponding with the groove of the connecting element, with the projection of the connecting compartment being received by the groove of the connecting element.

In a fourth embodiment of the measuring device of the invention, at least one of the two connecting elements has mutually essentially parallelly directed, electrically conductive, plug elements and the other of the two connecting elements has mutually essentially parallelly directed, electrically conductive, socket elements corresponding to the plug elements, with the plug elements being inserted into the socket elements and so contacting these, that sensor and measuring device electronics are electrically connected together and with plug elements and socket elements being directed essentially parallelly to the at least one groove of the connecting compartment and/or to the at least one projection of the connecting compartment.

In a fifth embodiment of the measuring device of the invention, both the plug elements and the socket elements extend into the connecting compartment.

In a sixth embodiment of the measuring device of the invention, at least one of the plug elements and/or at least one of the socket elements is mounted laterally and/or rotatably movably within the connecting element of which it is a part.

In a seventh embodiment of the measuring device of the invention, the at least one groove of the side wall and the projection corresponding with such are so arranged, that an installed position of the sensor module codes uniquely relative to the electronics module and prevents an erroneous assembly.

In an eighth embodiment of the measuring device of the invention, for preventing an erroneous assembly of sensor module and electronics module, the at least one projection of the connecting compartment and the groove of the particular connecting element corresponding with such are so arranged, that an installed position of the sensor module relative to the electronics module is uniquely determined.

In a ninth embodiment of the measuring device of the invention, for preventing an erroneous assembly of the sensor module and the electronics module, the at least one groove of the connecting compartment and the projection of the particular connecting element corresponding with such are so arranged, that an installed position of the sensor module relative to the electronics module is uniquely determined.

In a tenth embodiment of the invention, the measuring device further includes an essentially ring-shaped seal, which is so arranged in the connecting compartment, that it laterally surrounds at least one of the two connecting elements and contacts with an external side at least one side wall of the connecting compartment.

In an eleventh embodiment of the measuring device of the invention, the seal is arranged coaxially, especially concentrically, with the surrounded connecting element.

In a twelfth embodiment of the measuring device of the invention, the seal is arranged within the connecting compartment in the region of a peripheral gap in the side wall of the connecting compartment, and, indeed, lying between connecting element and side wall of the connecting compartment.

In a thirteenth embodiment of the measuring device of the invention, the seal has on the outside contacting the side wall of the connecting compartment two sealing lips extending essentially in parallel with one another.

In a fourteenth embodiment of the measuring device of the invention, the seal is so arranged in the connecting compartment that the two sealing lips extend essentially in parallel with the gap in the side wall of the connecting compartment.

In a fifteenth embodiment of the measuring device of the invention, the seal is so arranged in the connecting compartment that the gap in the side wall of the connecting compartment extends essentially between the sealing lips of the seal.

The measuring device of the invention offers the advantage that the electrical connection in the case of removal of the electronics module from the sensor module, especially in the case of use of the integrated plugging system including the two connecting elements, is automatically disconnected. The required plugging path and, consequently, the need for room for the replacement of the electronic module can, in this way, be considerably lessened, for example to about 25 mm. If necessary, the measuring device electronics can then be withdrawn from the electronics module and repaired or even replaced with a complete electronics module. Moreover, the correct positioning and contacting of the electronics module with the sensor module during assembly can be assured in simple manner by a mechanical coding and centering. The first connecting element is, for such purpose, fixedly connected with the sensor module, and the second connecting element is mounted limitedly movably in the sensor module. In this way, the tolerances can be accommodated and whatever plug contacts are present remain protected from additional loading. The sensitive electrical plug contacts are, moreover, arranged sunken in the electronics module and are thus protected against inadvertent damage.

A further advantage of this measuring device lies in the fact that it is modularly constructed. Electronics and sensor are separate components, which can be used independently of one another and are connected together only by the connecting elements. In this way, the measuring device can be manufactured with small complexity and offers a high measure of flexibility. E.g. a kit containing various electronics units and various sensor types can be provided, which can be combined with one another in any manner.

The invention and further advantages will now be explained in greater detail on the basis of the drawing illustrating an example of an embodiment. The figures of the drawing show as follows:

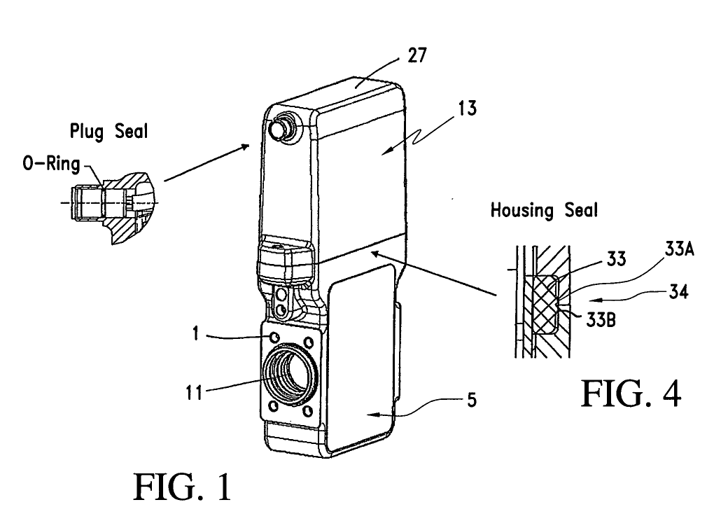

FIG. 1 in perspective, a modular measuring device having a sensor module and an electronics module;

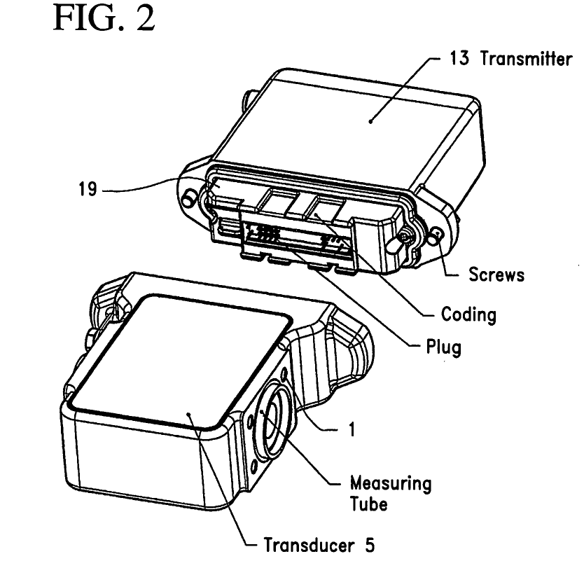

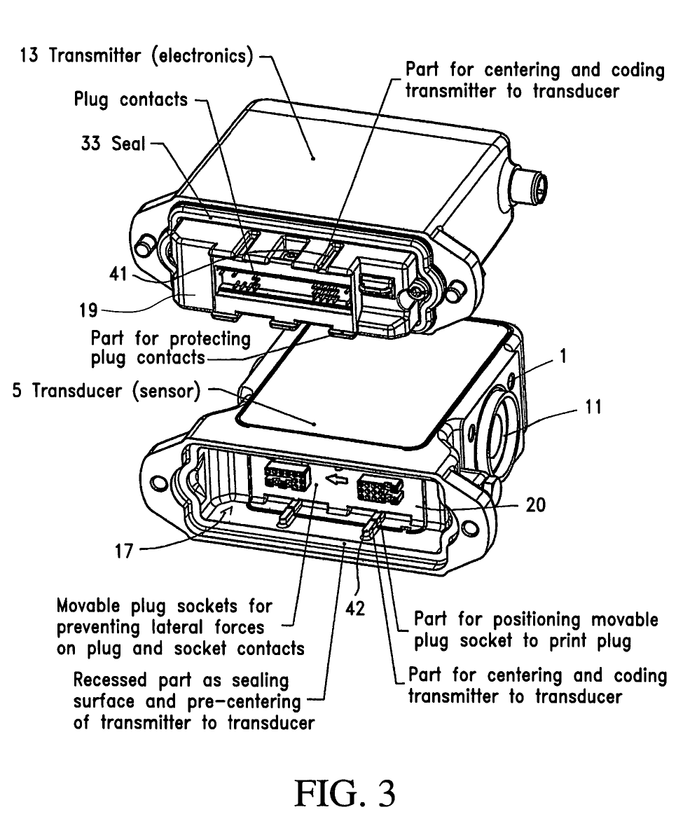

FIGS. 2, 3 in perspective, the measuring device of FIG. 1, showing an electronics module separated from the sensor module; and

FIG. 4 in cross section, a seal suited for the measuring device of FIG. 1.

FIGS. 1 to 3 show a modular measuring device, including a sensor module 5 having a sensor compartment in which a physical-to-electrical sensor 7 is arranged, and an electronics module 13 having an electronics compartment in which a measuring device electronics is arranged. The sensor 7 can be e.g. a pressure sensor, a temperature sensor, a capacitive, fill-level probe, an ultrasonic sensor or a microwave emitting and receiving, microwave module, or, as shown here, a flow meter insertable into the course of a pipeline.

Furthermore, the measuring device has a first connecting element 19 mounted on the electronics module 13 and electrically connected with the measuring device electronics 7, and a second connecting element 20 mounted on the sensor module 5 and electrically connected with the sensor 7. Sensor module 5 and electronics module 13 are releasably, mechanically connected together, accompanied by the formation of a connecting compartment 17 lying between the sensor compartment and the electronics compartment, especially a connecting compartment sealed fluid-tightly and/or pressure-tightly relative to the surrounding atmosphere. The two connecting elements 19, 20 are electrically, especially galvanically, connected together, so that measuring device electronics and sensor are electrically coupled together, with the two mutually connected, connecting elements being accommodated in the connecting compartment 17 formed between the sensor and electronics compartments.

In an embodiment of the invention, at least one of the two connecting elements has electrically conductive, plug elements directed essentially in parallel with one another, and the other of the two connecting elements has electrically conductive, socket elements corresponding to the plug elements and directed essentially in parallel with one another. The plug elements are inserted into the socket elements and contact there such that sensor 7 and measuring device electronics 7 are electrically connected together.

The measuring device is provided and suited to be used at a measuring site, for example to be inserted into the course of a fluid line (not shown). To this end, the sensor module 5 has, as shown schematically in FIGS. 1 to 3, a measuring tube 11, as well as flanges 1 applied thereto, by means of which the measuring device is mountable to corresponding, counter-flanges. The sensor module 5 is enclosed by a cassette-shaped, module housing.

Besides the sensor module 5, the measuring device further includes an electronics module 13 mechanically and electrically connected with the sensor module. The electronics module 13 contains a measuring device electronics (not shown in FIG. 1). The electronics module 13 is likewise enclosed by a cassette-shaped module housing.

Between sensor module 5 and electronics module 13, a connecting compartment 17 is formed, by which the electronics module 13 and the sensor module 5 are connected. The connecting element 19 extends into the connecting compartment 17 and closes the connecting compartment 17. The sensor-facing end of the connecting element 19 has an outer geometry, which is essentially equal to an inner geometry of the connecting compartment 17.

In a further embodiment of the invention, a side wall of one of the two connecting elements 19, 20 has an essentially straight groove 41 and a side wall of the connecting compartment has an essentially straight projection 42 corresponding with the groove 41 of the connecting element, with the projection of the connecting compartment being received by the groove of the connecting element, as is evident from a comparison of FIGS. 1 to 3. Alternatively or in supplementation thereof, it is also possible that the side wall of one of the two connecting elements has an essentially straight projection, with the side wall of the connecting compartment, in such case, being provided with an essentially straight groove corresponding with the projection of the connecting element, so that the projection of the connecting element is then received by the groove of the connecting compartment.

For the mentioned case, in which the two connecting elements 19, 20 have matching plug and socket elements, these plug and socket elements are essentially directed in parallel to the at least one groove of the connecting compartment and/or to the at least one projection of the connecting compartment, in order to enable a plugging together.

For protecting the sensitive plug and socket elements, the connecting elements are preferably so constructed that both the plug elements as well as also the socket elements protrude into the connecting compartment and/or the plug elements and/or the socket elements are mounted laterally and/or rotatably movable within their connecting elements.

In a further embodiment of the invention, at least one of the two connecting elements is movably mounted.

By the movable mounting of the connecting elements and/or the plug and socket elements, possible variations due to manufacturing tolerances can be accommodated and the existing plug contacts protected from extra loads.

In an advantageous embodiment of the invention, the groove of the side wall and the projection of the connecting element corresponding therewith and/or the projection of the connecting compartment and the groove of the connecting element corresponding therewith are so arranged, that an installed position of the sensor module 5 codes uniquely relative to the electronics module 13, whereby an erroneous assembly is effectively prevented.

In an embodiment of the invention, a seal 33, for example of an elastomer, is provided where the two modules border one another and so form a peripheral gap 34. The essentially ring-shaped seal is so arranged in the connecting compartment that it laterally encloses at least one of the two connecting elements and contacts with an outer side at least one sidewall of the connecting compartment. As shown in FIGS. 2 and 3, the seal is coaxial, especially concentric, with the enclosed connecting element.

In the example of an embodiment shown in FIGS. 2 to 4, each of the two module housings has a cylindrical section, and these two cylindrical sections are aligned with one another. Each of the two inner, cylindrical sections has a ring-shaped, peripheral shoulder, in which the seal 33 is so mounted that the seal is arranged within the connecting compartment in the region of the gap extending around the side wall of the connecting compartment. The seal lies, in such case, between the connecting elements and the side wall of the connecting compartment.

In a further development of the invention, the seal has on its outer side contacting the side wall of the connecting compartment two sealing lips 33A, 33B extending essentially in parallel with one another. The seal 33 is, in such case, preferably so arranged in the connecting compartment that the two sealing lips extend essentially in parallel with the gap 34 in the side wall of the connecting compartment 17. Advantageously, the seal is so arranged in the connecting compartment that the gap in the side wall of the connecting compartment extends essentially between the sealing lips of the seal.

The measuring device electronics is an electronic circuit mounted on one or more circuit boards, and the circuit boards are insertable into slots located in the interior of the electronics module and connected with the connecting element or integrated into such. At the slots, electrical contact elements are provided, which produce electrical contact upon the insertion of the circuit boards.

On the sensor-facing side of the connecting element 19, terminals are provided, to which terminals of the connecting element 20 corresponding thereto are connectable. These terminals are e.g. clamping plugs, into which connecting lines 25 of the sensor 7 are insertable. The terminals are likewise, in each case, connected internally in the connecting element 19 with a contact element and connected thereby to the electrical circuit.

Preferably, remaining, free voids inside the electronics module and inside the connecting element 19 mounted therein are filled with a potting compound, e.g. a silicone gel.

The electronics module 13 has an opening, through which the measuring device electronics is introduced during its assembly. The opening is closed with a releasable housing lid 27. When the housing lid 27 is open, the connecting clamps 23 are accessible. Further provided is a hermetically sealed feedthrough, through which external lines are guided into the electronics module 5. These external lines are then connected to the connecting clamps 23.

1-15. (canceled)

16. A modular measuring device, comprising:
a sensor module having a sensor compartment, in which a physical-to-electrical sensor is arranged;
an electronics module, having an electronics compartment, in which a measuring device electronics is arranged;
a first connecting element mounted on said electronics module and electrically connected with said measuring device electronics; and
a second connecting element mounted on said sensor module and electrically connected with said sensor;
wherein:
said sensor module and said electronics module are releasably, mechanically connected together, accompanied by the formation of a connecting compartment lying between said sensor compartment and said electronics compartment, preferably a connecting compartment sealed fluid-tightly, and/or pressure-tightly, relative to a surrounding atmosphere;
said two connecting elements are electrically, preferably galvanically, connected together, so that said measuring device electronics and said sensor are electrically coupled together; and
said two connecting elements, connected together, are accommodated in the connecting compartment formed between said sensor compartment and said electronics compartment.

17. The measuring device as claimed in claim 16, wherein:
at least one of said two connecting elements is movably mounted.

18. The measuring device as claimed in claim 16, wherein:
at least one side wall of at least one of said two connecting elements has at least one essentially straight groove and at least one side wall of said connecting compartment has at least one, essentially straight projection corresponding with said groove of said connecting element; and the projection of said connecting compartment is received by said groove of said connecting element.

19. The measuring device as claimed in claim 16, wherein:
at least one side wall of at least one of said two connecting elements has at least one essentially straight projection and at least one side wall of said connecting compartment has an essentially straight groove corresponding with the projection of said connecting element; and
the projection of said connecting element is received by the groove of said connecting compartment.

20. The measuring device as claimed in claim 18, wherein:
at least one of said two connecting elements has electrically conductive, plug elements directed essentially in parallel with one another; and
the other of said two connecting elements has electrically conductive, socket elements directed essentially in parallel with one another and corresponding to said plug elements;
said plug elements are inserted into said socket elements and so contact said socket elements, that said sensor and said measuring device electronics are electrically connected together; and
said plug elements and said socket elements are directed essentially in parallel with said at least one groove of said connecting compartment and/or with the at least one projection of said connecting compartment.

21. The measuring device as claimed in claim 20, wherein:
both said plug elements and said socket elements protrude into said connecting compartment.

22. The measuring device as claimed in claim 20, wherein:
at least one of said plug elements and/or at least one of said socket elements is mounted laterally and/or rotatably movably within said connecting element of which it is a part.

23. The measuring device as claimed in claim 18, wherein:
for preventing an erroneous assembly of said sensor module and said electronics module, the at least one projection of said connecting compartment and said connecting element groove corresponding with such are so arranged, that an installed position of said sensor module relative to said electronics module is uniquely determined.

24. The measuring device as claimed in claim 18, wherein:
for preventing an erroneous assembly of said sensor module and said electronics module, the at least one groove of said connecting compartment and said connecting element projection corresponding with such are so arranged, that an installed position of said sensor module relative to said electronics module is uniquely determined.

25. The measuring device as claimed in claim 16, further comprising:
an essentially ring-shaped seal, which is so arranged in said connecting compartment, that it laterally surrounds at least one of said two connecting elements and contacts with an external side at least one side wall of said connecting compartment.

26. The measuring device as claimed in claim 25, wherein:
said seal is arranged coaxially, especially concentrically, with the surrounded connecting element.

27. The measuring device as claimed in claim 25, wherein:
said seal is arranged within said connecting compartment in the region of a peripheral gap in the side wall of said connecting compartment, and lying between said connecting element and side wall of said connecting compartment.

28. The measuring device as claimed in claim 25, wherein:
said seal has on its outside, contacting the side wall of said connecting compartment, two sealing lips extending essentially in parallel with one another.

29. The measuring device as claimed in claim 27, wherein:
said seal is so arranged in said connecting compartment that the two sealing lips extend essentially in parallel with said gap in the side wall of said connecting compartment.

30. The measuring device as claimed in claim 29, wherein:
said seal is so arranged in said connecting compartment that said gap in the side wall of said connecting compartment extends essentially between the sealing lips of the seal.
